(19) United States
(12) Patent Application Publication
(10) Pub. No.: US 2004/0118283 A1
(43) Pub. Date: Jun. 24, 2004

(54) Filter system and method for cleaning filter elements in a powder coating apparatus

(75) Inventor: Uwe Hering, Lueneberg (DE)

Correspondence Address: KEVIN G. ROONEY, WOOD, HERRON & EVANS, L.L.P., 2700 CAREW TOWER, CINCINNATI, OH, 45202, US

(73) Assignee: Nordson Corporation

(21) Appl. No.: 10/675,146

(22) Filed: Sep. 30, 2003

(30) Foreign Application Priority Data
Oct. 1, 2002 (DE) 10246126.0

(51) Int. Cl. B01D 46/04

(52) U.S. Cl. 95/280; 95/282; 55/300; 55/302

(57) ABSTRACT

A filter system and a method for cleaning a gas laden with powder particles, in particular for a powder coating apparatus. At least one filter element is arranged between a crude gas chamber and a clean gas chamber. A first gas discharge device directs a gas stream from the crude gas chamber through the filter element into the clean gas chamber. A shut-off device interrupts the first gas stream through the filter element, and a second or cleaning gas discharge device directs a cleaning gas stream through the filter element into the crude gas chamber. A vibration device vibrates and/or shakes the filter element to dislodge powder from the filter element.

### CROSS-REFERENCE TO RELATED APPLICATION

This application claims the priority of German Application Serial No. 10246126.0, filed Oct. 1, 2002, and the disclosure of which is hereby incorporated by reference herein.

### FIELD OF THE INVENTION

The present invention relates to a system and method for cleaning a filter and, in particular, for cleaning one or more filter elements of a powder coating apparatus.

### BACKGROUND OF THE INVENTION

A filter system and method of this kind are known, for example from DE 38 13 259 C2. In order to coat objects with powder, the objects to be coated are introduced into coating chambers in which powder particles are present that deposit themselves onto the objects to be coated.

The coated objects are subsequently conveyed or otherwise taken out of the coating chamber. Some of the powder particles present in the coating chamber are not deposited onto the object and remain in the coating chamber, where they usually accumulate on the floor of the coating chamber. These surplus amounts of powder are recovered and then fed again into the coating chamber. To this end, underpressure or vacuum is generated in the coating booth with the help of a blower or the like, thus generating a gas stream that conveys surplus powder particles out of the coating chamber back into a crude gas chamber. A conventional powder coating filter system includes such a crude gas chamber, at least one filter element and a gas moving device such as a blower for generating a gas stream from the crude gas chamber through the filter element into a clean gas chamber. This also generates the underpressure in the coating chamber.

Powder particles accumulate in the filter element(s) during filtering, particularly on the surfaces thereof. The amount of powder particles retained in the filter element increases over time, with the result that the flow resistance through the filter element also increases over time. Filtering is impaired as a consequence. In order to counteract these adverse effects, the filter element(s) must be cleaned from time to time. To this end, a gas stream is generated in the powder recovery system known from DE 38 13 259 by means of a blow-out nozzle. The gas stream is directed into the interior(s) of the filter element(s) to detach powder particles adhering to the filter element(s) and to blow them downwards to the floor of the crude gas chamber. The results obtained with the known powder recovery system are usable, but the cleaning times are so long that coating operations are interrupted for a relatively long time. The blow-out nozzles generate gas streams in the direction of the filter element to only a partial extent, so the filter is only partially cleaned.

The object of the present invention is to provide a filter system, a coating apparatus and a method for more rapidly cleaning one or more filters designed to collect powder.

### SUMMARY OF THE INVENTION

The invention generally comprises a filter system having a shut-off device for interrupting a first gas stream through a filter element, a gas moving device which generates a second gas stream through the filter element into a crude gas chamber, and a filter moving device which vibrates or shakes the filter element and thus dislodges powder therefrom. The invention further contemplates a powder coating apparatus having a filter system according to the invention.

According to the method of this invention, the second gas stream is directed through the filter element in the direction of the clean gas chamber and the filter element is vibrated and/or shaken such that powder particles present in the filter element are detached from the filter element.

With the filter system according to the invention and the method according to the invention, one or more filter elements can be cleaned very efficiently and quickly. The first gas stream through the filter element in the direction of the clean gas chamber is interrupted by the shut-3 off device, then a cleaning or second gas stream is directed through the filter element in the direction of the crude gas chamber, and the filter element is simultaneously vibrated and/or oscillated so that the filter elements are extensively freed of powder particles not only by the cleaning gas stream, but additionally by the mechanical vibrating, knocking or oscillating movement. The time needed to clean the filter elements is significantly reduced by the apparatus and method according to the invention.

According to another aspect of the invention, a second gas discharge device is provided for generating a cleaning gas stream through the filter element. The second gas discharge device includes at least one movable nozzle element for supplying at least one cleaning gas stream directed at the filter element. According to this aspect of the invention, the cleaning gas stream is directed through the filter element in the direction of the clean gas chamber. The advantages of this aspect of the invention include the ability to discharge the cleaning gas stream at several places, over a large area, such that the filter element is cleaned uniformly and very completely. Compared to immovable, stationary blow-out nozzles, this leads to the filter being cleaned significantly more efficiently and in considerably shortened cleaning times. According to this aspect of the invention, a filter moving device preferably vibrates and/or shakes the filter element, pursuant to a previously described aspect, in order to reduce still further the time required to clean the filter system. However, it is not imperative to use such a filter moving device means. It has been established in tests that fast and complete cleaning of the filter system is also possible with only one movable nozzle element.

One preferred embodiment of the filter cleaning system according to the invention is characterized in that two filter elements are arranged in parallel between the crude gas chamber and the clean gas chamber, and each filter element is assigned a shut-off device for interrupting the first gas stream. Each filter element is also coupled with a filter moving device which shakes and/or vibrates the filter element. By virtue of this parallel arrangement of two filter elements according to the invention, the filter system can be operated continuously, with only one of the two filters being cleaned temporarily while the other filter remains in operation to filter the gas. Due to the fact that a cleaning gas stream is generated and the filter element is vibrated, the cleaning times can be kept short, with the result that both or several filter elements are available most of the time.

In one development of the invention it is proposed that the filter element is disposed inside a frame and that the filter moving device is associated with the frame such that the frame and the filter element disposed inside the frame are caused to vibrate or shake. This simple construction enables efficient vibration and efficient knocking of the filter element to be achieved.

The filter moving device appropriately comprises a pneumatic cylinder that can be intermittently charged with pressure gas. The piston is movable within the cylinder and is connected by a piston rod to the frame. Vibration can be applied particularly well by a plate being attached to a free end of the piston rod, and the plate can be brought into contact with the frame. Owing to the mass of the plate, it is also possible to achieve an optimal setting of the vibration system comprising the filter element, the frame and the piston rod.

In an alternative embodiment, the frame for receiving the filter element is disposed at a distance plate positioned between the crude gas chamber and the clean gas chamber, and the filter vibrating device is mounted on the distance plate. With the help of such a distance plate, the separate parts can be easily assembled and disassembled, and the filter elements can be easily replaced.

A cover plate covering the frame is separably attachable to the frame, and an outlet opening is formed in the cover plate for discharging cleaned gas into the clean gas chamber. The shut-off device comprises a movable shut-off member for closing the outlet opening. Efficient feeding of a cleaning gas stream is thus achieved with a simple constructional design. The shut-off device preferably comprises a pneumatic cylinder that can be charged with pressure gas, and the shut-off member of the shut-off device is connected by a piston rod to a piston that is movable inside the pneumatic cylinder.

One preferred embodiment of the filter system with a movable nozzle element is one in which the nozzle element is rotatingly mounted on bearings and is capable of being driven. Such a rotable mounting is particularly easy and inexpensive to design and construct. This embodiment is developed by the nozzle element having at least one elongated arm with a gas channel and a plurality of gas outlet channels directed at the filter element. Such an elongated arm with a plurality of gas outlet channels ensures that the gas feed is simple and that a large area of the filter element receives the gas feed.

A particularly preferred development of this embodiment is one in which the gas outlet channels are so arranged that the movable arm can be rotatably driven by the outflowing gas. Thus, a single gas feed into the movable arm can discharge as one or several gas streams into the filter element and simultaneously rotate the movable nozzle element. It is particularly preferred that the longitudinal axes of the gas outlet channels are positioned spaced apart on the arm and slanted with respect to a rotational axis, preferably at an angle of 15°-30°, and particularly preferably at an angle of about 22°.

In an alternative embodiment, it is proposed that the second gas or cleaning gas is conveyed by a device that has several flow channels for feeding pressure gas into the filter elements, and that the inlet openings can be connected to a pressure gas source by way of a pressure gas distributor mounted on the cover plate. This means that the cleaning gas is fed in at several locations, thus achieving efficient cleaning of the filter.

According to one preferred embodiment, the method according to the invention is developed such that two filter elements are arranged in parallel between the crude gas chamber and the clean gas chamber, and that, in order to clean one of the filter elements, the gas stream into the clean gas chamber is interrupted by a shut-off device assigned to a first one of the filter elements, while a gas stream continues to flow through the other filter element in order to clean the gas. A cleaning gas stream is directed through the first filter element in the direction of the clean gas chamber and while the cleaning gas stream is flowing through the first filter element, the first filter element is vibrated and/or shaken such that powder particles present in the first filter element are detached from the first filter element. In this way, operation can be maintained at all times.

Other advantageous developments of the invention are described herein. With regard to the advantages of the invention, reference is made to the descriptions of the filter system according to the invention in the foregoing and to the description that follows.

### BRIEF DESCRIPTION OF THE DRAWINGS

The invention will now be described on the basis of embodiments and with reference to the drawings. The drawings show:

FIG. 1 is a perspective view of a powder coating apparatus with a coating chamber and integrated filter system.

FIG. 2 is a schematic view of a filter system integrated in a powder coating apparatus.

FIG. 3 is a perspective view of a portion of the system according to the invention as shown in FIG. 1.

FIG. 4 illustrates the portion from FIG. 3 in a perspective view from the rear.

FIG. 5 is a perspective view of a cover plate with components of the filter system.

FIG. 6 is a side elevation view of that part of the system shown in FIG. 5.

FIG. 7 is a plan view of that part of the system shown in FIG. 5.

FIG. 8 is a perspective plan view of a portion of an alternative embodiment of a filter system with a movable nozzle element.

FIG. 9 is a side elevation view of the filter system pursuant to FIG. 8.

FIG. 10 is a further side elevation view of the filter system pursuant to FIG. 8.

FIG. 11 is a plan view of the filter system pursuant to FIG. 8.

FIG. 12 is a view from below the filter system pursuant to FIG. 8.

FIG. 13 is a perspective view of a movable nozzle element.

FIG. 14 illustrates the nozzle element in FIG. 13 in a plan view.

FIG. 15 is a side elevation view of the nozzle element in FIG. 13.

FIG. 16 illustrates the nozzle element pursuant to FIG. 13 in a further side elevation view.

### DETAILED DESCRIPTION OF THE PREFERRED EMBODIMENTS

One preferred embodiment of a powder coating apparatus 1 shown in a perspective view in FIG. 1 comprises a rack frame 2 having a total of four rollers for easy movement of the entire powder coating apparatus 1. A control and regulation device 4 with a display and operating panel is disposed in the upper part on the rack frame 2 and serves to control and regulate the separate components of the powder coating apparatus 1. A coating booth 8 is supported laterally at a distance from the rack frame 2 by a support 10. In this embodiment, the coating chamber 8 serves to coat a cable with powder, for example talcum or superabsorbent powder. The cable to be coated can be fed through a feed opening 12 into the coating chamber 8 and conveyed out of the coating chamber 8 through an opposite outlet opening, not shown. A device for supplying and feeding powder, in the form of a powder spray gun 14, sprays powder into the coating chamber 8 in the direction of the object to be coated. The spray gun can be, for example, a Tribomatic or other type of spray gun.

A filter system 16 for cleaning a gas laden with powder particles or for recovering powder particles from a gas stream is shown schematically in FIG. 2. The filter system 16 is disposed inside a rack frame 2 (FIG. 1) and mainly serves in the embodiment shown to recover powder that has not been deposited onto the object to be coated inside coating booth 8. A suction line 18 connects to the coating chamber 8 (FIG. 1) and to a crude gas chamber 20. In this manner, underpressure or vacuum is generated inside the coating chamber 8 and surplus powder is conveyed with the gas stream out of the coating chamber 8 into the crude gas chamber 20. The underpressure in the crude gas chamber 20 is generated by a blower 22 in the form, for example, of a side-channel compressor, the blower being directed into a pipe 24 and mounted inside the upper portion of the rack frame 2. The filter system 16 comprises two filter elements 26, 28 arranged in parallel (FIG. 2) between the crude gas chamber 20 and a clean gas chamber 30, and a blower 22 for generating a gas stream from the crude gas chamber 20 into the clean gas chamber 30. In operation, powder particles are retained and recovered by the filter elements 26, 28. The particles mostly fall back onto the floor 32 of the crude gas chamber 20 and can be re-used for powder coating by conveying them through line 19 to the coating chamber. Underpressure is generated by the blower 22 in the crude gas chamber 20 and, by means of line 18, in the coating chamber 8 as well.

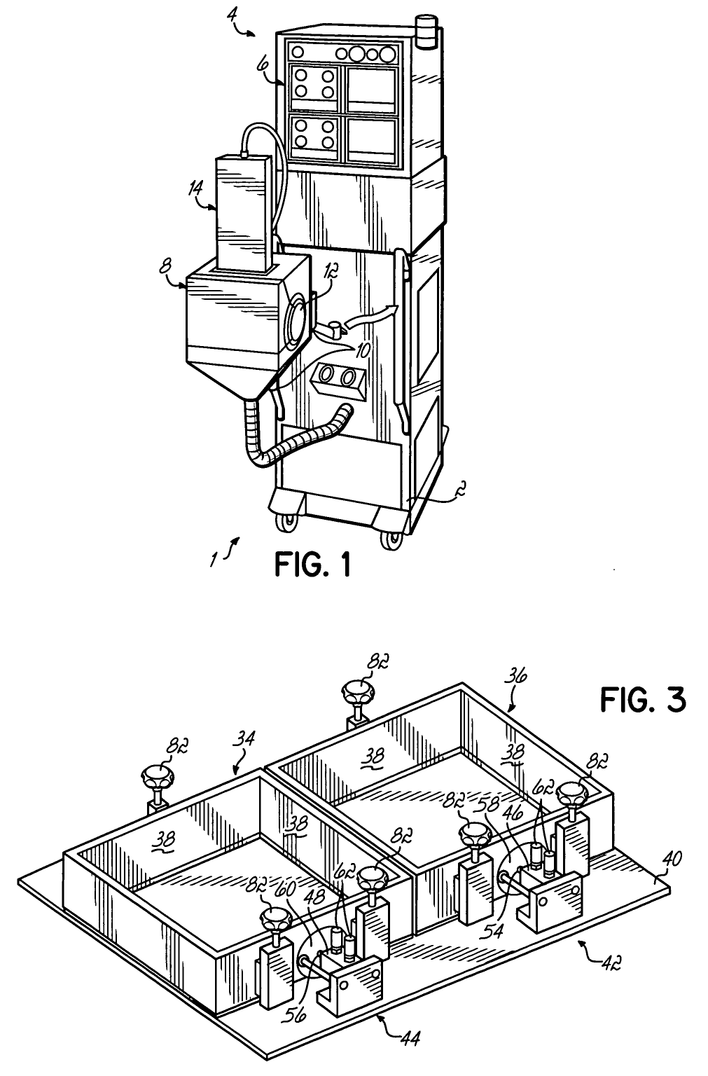

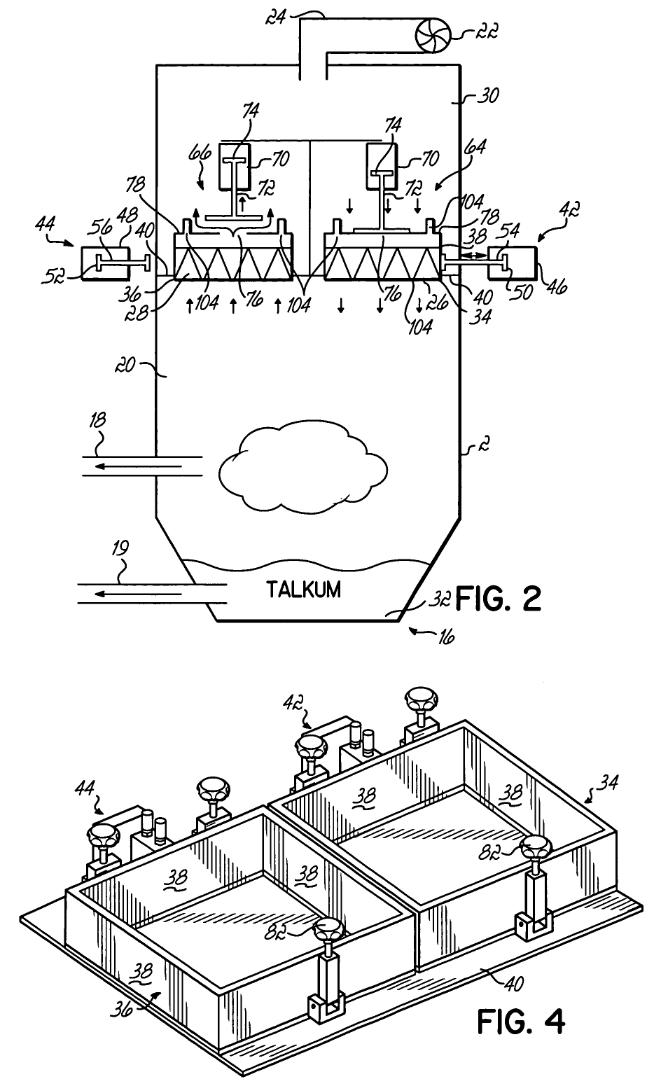

As can be seen not only from the schematic view in FIG. 2, but also from the view of a preferred embodiment in FIGS. 3 and 4, the two filter elements 26, 28 are each housed inside a substantially parallelepipedal frame 34, 36. Frames 34, 36 are made of wooden boards 38 and mounted onto a distance plate 40 that is positioned between the crude gas chamber 20 and the clean gas chamber 30 and attached to the rack frame 2.

Each frame 34, 36 and hence each filter element 26, 28 is assigned a vibration device 42, 44 for vibrating and/or shaking or knocking the filter elements 26, 28. Each vibration device 42, 44 is mounted on the distance plate 40 and comprises a pneumatic cylinder 46, 48 that can be intermittently charged with pressure gas, and pistons 50, 52 movable back and forth within the cylinder (FIG. 2). Each piston 52 is connected to a piston rod 54, 56, at the free end of which a plate 58, 60 is attached that can be brought into contact with frame 34 and 36, respectively. When piston 50, 52 moves intermittently back and forth, plate 58, 60 and piston rods 54, 56 knock against the frame 34, 36 and cause the latter and filter element 26, 28 disposed inside the frame 34, 36 to vibrate or oscillate, with the result that filtered particles adhering to the surface of filter elements 26, 28 fall down into the crude gas chamber 20. In order to generate the back-and-forth movement of the pistons 50, 52, pressure gas connections 62 shown in FIGS. 3 and 4 are connected to the cylinders 46, 48 such that pressure gas for generating the vibration can be fed from a pressure gas source (not shown) into the cylinder. Control device 4 is used for this purpose.

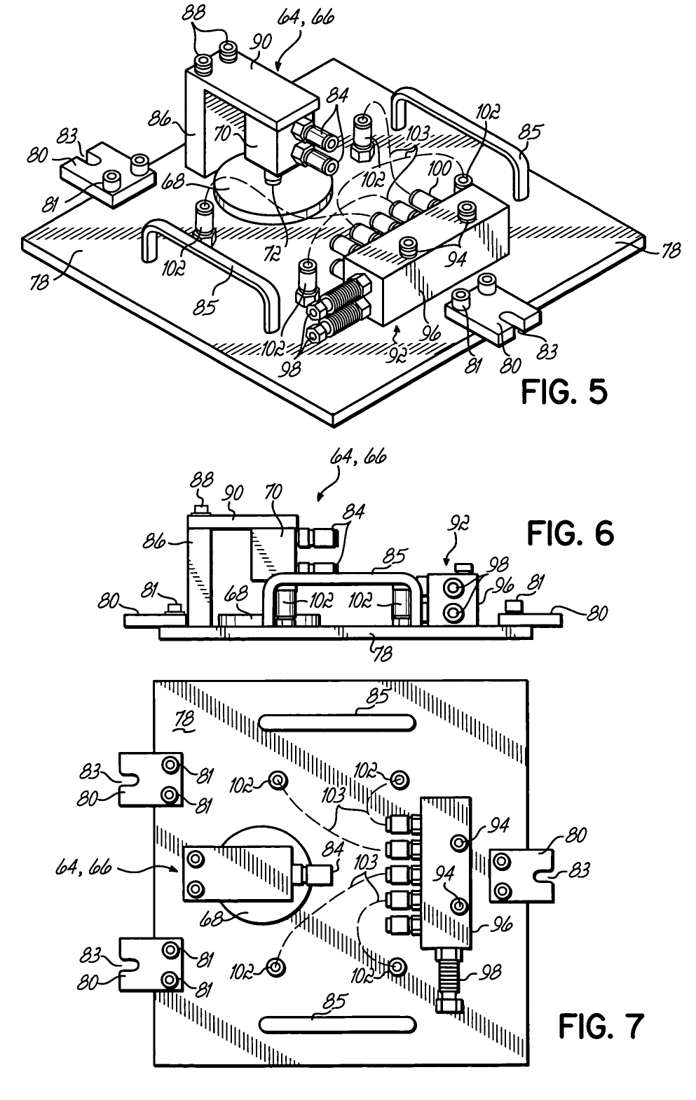

As shown by FIGS. 2 and 5, each filter element 26, 28 is assigned a shut-off device 64, 66 for interrupting the gas stream through the respective filter elements 26 and 28. In FIG. 2, the shut-off device 66 in the left-hand portion is shown in the open position and the shut-off device 64 in the right-hand portion is shown in the closed position. With reference to FIG. 5, each shut-off device 64, 66 comprises a movable shut-off member 68 in the form of a circular plate, and a pneumatic cylinder 70 that can be charged with pressure gas. Each of the cylinders include a piston rod 72 connected to a piston 74 that is movable inside the pneumatic cylinder 70 (FIG. 2). Each shut-off member 68 is so designed that, when in the closed position, it closes a respective outlet opening 76 formed in a cover plate 78.

Each cover plate 78 (FIG. 5) covers the top side of the frame 36, 38 housing the filter elements 26, 28 (FIG. 3). A cover plate 78 as shown in FIG. 5, including the components mounted thereon, can be placed upon and fastened to each of frames 36, 38 (FIG. 3) for this purpose. Fastening is done with fixing plates 80 that have slots 83, the plates being screwed onto the cover plate 78 with fixing screws 81 (FIG. 5), and with a plurality of thumb screws 82 attached to frames 36, 38. The shanks of the thumb screws are insertable into slots 83 of the fixing plates 80 to fasten the cover plate 78 onto frames 36, 38. In a manner not shown, thumb screws 82 are pivotably hinged to frames 36, 38 in such a way that the thumb screws 82 can be removed entirely from slots 83 in fixing plates 82. The cover plate 78 can be lifted by handles 85.

As FIG. 5 illustrates, each cylinder 70 has two pressure gas connections 84 such that a connection to a pressure gas source can be established using control device 4 (FIG. 1) in order to bring the shut-off member 68 into the open or closed position. The pneumatic cylinder 70 is held in place by a plate 86 mounted on the cover plate 78 (FIG. 5) and by an additional plate 90 that is fixed by screws 88 onto the fixed plate 86.

As best shown by FIGS. 5-7, a second or cleaning gas discharge device 92 for generating a gas stream through the filter element 26 into the crude gas chamber 20 is provided in order to generate a stream through the filter element 26 into the crude gas chamber 20 when the shut-off device 64 (FIG. 2, right-hand portion) is closed, so that the filter elements 26, 28 are cleaned at the same time as the vibration device 42, 44 is switched on. Device 92 for supplying clean gas comprises a pressure gas distributor attached to the covered plate 78 and in the form of a manifold block 96, the manifold block having two pressure gas connections 98 for feeding pressure gas and for establishing a connection to a pressure gas source (not shown in the Figures). In addition, a plurality of outlet connections 100 are mounted on the manifold block 96, the connections being connectable to a plurality of connections 102 by tubes indicated by the broken lines 103. Connections 102 are connected to the flow channels provided in the cover plate 78, schematically shown in FIG. 2 by the reference numeral 104, through which pressure gas can be fed into the filter elements 26, 28.

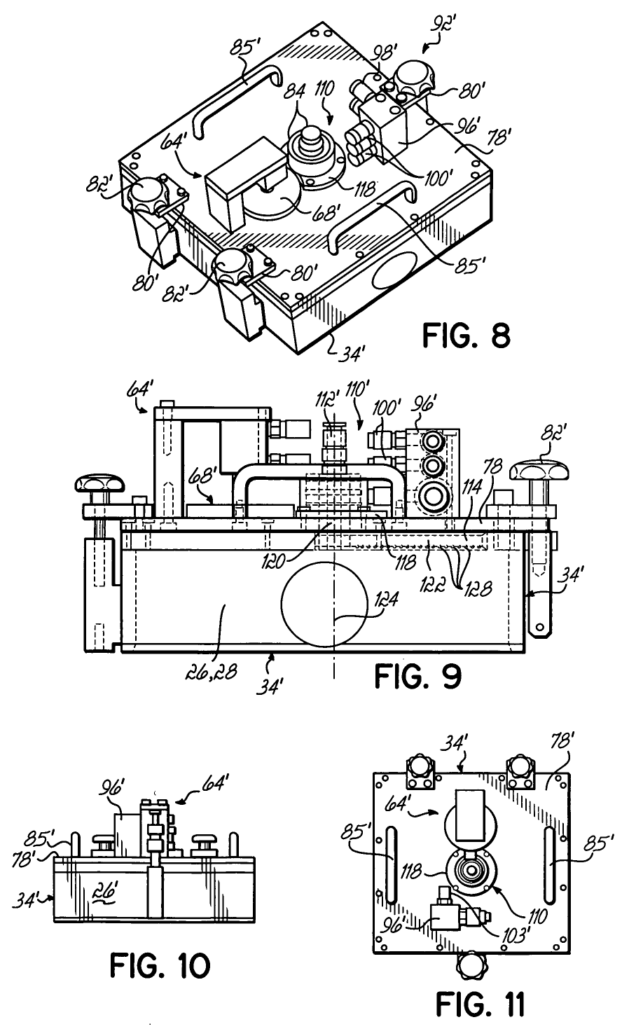

An alternative embodiment of a filter system shall now be described in more detail with reference to FIGS. 8-16. The filter system portion shown in FIGS. 8-16 is for use in a powder coating apparatus 1 pursuant to FIGS. 1 and 2 described in the foregoing. Reference is made in that regard to the entire descriptions provided above, using the same numerals and describing in the following the main differences in the alternative embodiment.

As FIGS. 8-10 illustrate, a parallelepipedal frame for receiving a filter element 26, 28, as shown in FIG. 2, is disposed between the crude gas chamber 20 and the clean gas chamber 30 (FIG. 2). Preferably, two frames 34′, 36 are arranged in parallel, as shown in FIG. 2. A cover plate 78′ covers the frame 34′ and receives handles 85′ and a plurality of fixing plates 80′, with which the cover plate 78′ can be detachably fastened to the frame 34′ by a plurality of thumb screws 82′. The gas stream through the filter element 26 in the direction of the clean gas chamber 30 (FIG. 2) can be interrupted or released by a shut-off device 64′, in the manner described in the foregoing. By means of a manifold block 96′, pressure gas can be fed from a pressure gas source, not shown, through two pressure gas connections 98′ and dispensed through outlet connections 100′, and conveyed further by tubes that are not shown in the Figures. Two tubes lead to pressure gas connections 84′ of the shut-off device 64′ for moving a circular shut-off member 68′ up and down.

A second or cleaning gas discharge device 92′ serves to generate a gas stream through the filter element 26 inside frame 34′ and substantially comprises the manifold block 96′ and a nozzle facility 110 that has a movable nozzle element 114 for supplying one or several gas streams directed at the filter element. The nozzle element 114 is bolted onto the cover plate 78′ by an annular flange 118 attachable to a housing 116. The nozzle element 114 has a connecting piece 112 that is connected, in a manner not shown, to an outlet connection 100′ of the manifold block 96 so that pressure gas can be supplied. The connecting piece 112 leads into a gas channel 120 that runs into the middle of the housing 116 and communicates with a gas channel 122. Gas channel 122 is defined inside the movable nozzle element 114, which is configured as an elongated arm.

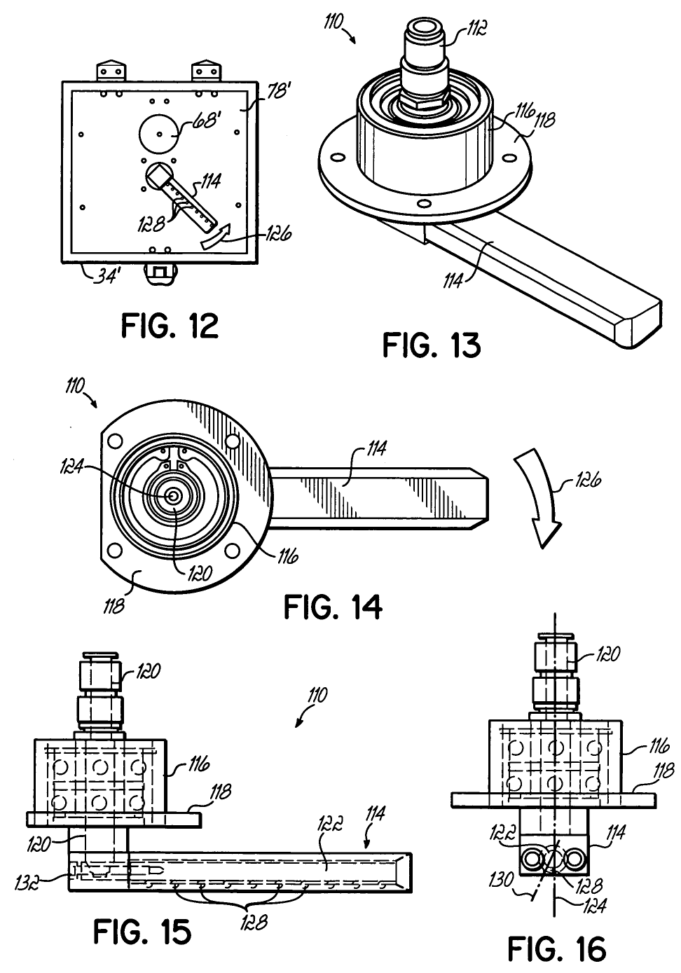

Nozzle element 114 is mounted rotatably about a rotational axis 124 (FIG. 14) by means of a ball bearing inside the housing 116 or some other pivot bearing, so that rotation can occur in the direction shown by arrow 126 (FIGS. 12 and 14). In this embodiment, pressure gas that flows through channel 120 and gas channel 122 and through several gas outlet channels 128 out of nozzle element 114 at relatively high speed is used to rotatably drive the rotatable nozzle element 114. The longitudinal axes 130 (FIG. 16) of the cylindrical outlet channels 128 are slanted in relation to the rotational axis 124, at an angle of about 22′, or precisely 21.8°, so that a torque that causes the rotatable nozzle element 124 to rotate ensues as a result of the gas flowing out of the outlet channels 128. Alternatively, the angle can be in a range between 15° and 30°.

The nozzle element 114 in the form of an elongated arm is disposed under the cover plate 78′ immediately adjacent and above the filter element 26 in such a way that the escaping gas streams flow directly onto the filter element 26, penetrating the latter and flowing at least partly in the direction of the crude gas chamber 20 (FIG. 2). Rotational speeds of up to around 60 to 80 revolutions per minute can be reached, as well as higher or lower speeds. For example, the gas can be fed into the nozzle element 114 at a pressure of 6 bar, and the cleaning time can be set to only six seconds, meaning that the pressure gas is supplied for a duration of six seconds. FIG. 12 shows, in a view from below, the rotatable nozzle element 114 and the cover plate 78′ of the filter element 26.

As FIGS. 10 to 12 illustrate, the nozzle facility 110 is attached centrally to the cover plate 78′, and the shut-off device 64′ is positioned off-center adjacent the nozzle facility 110. In FIG. 11, tubes 103′ are indicated, through which pressure gas can be conveyed from the manifold block 96′ to the shut-off device 64′ and the nozzle facility 110.

The nozzle element 114 is designed with a substantially square cross-section and is made of a flat material such as flat rolled steel. Gas channel 122 is bored through the center of the flat material. As is shown in FIGS. 13 and 14, the edges of the arm are beveled, for example by milling, so that they acquire a favorable aerodynamic profile. Alternatively, the corners of the arm can also be rounded. In a manner not shown in the Figures, the leading edge of the arm could also be designed so that it tapers to a point, in order to keep the flow resistance as low as possible. A screw plug 132 is used to seal the end of the gas channel 122.

The manner in which the filter system, powder coating apparatus and method according to the invention operate is as follows.

As can be seen from FIG. 1, powder is conveyed from the floor area of the crude gas chamber 20 through line 19 to spray gun 14, and fed into coating chamber 8 and sprayed there in order to spray and coat an object such as a cable. Surplus powder in the powder coating apparatus 8 is conveyed through line 18 into the crude gas chamber 20 by underpressure generated by the side-channel compressor 22 (FIG. 2). When shut-off device 66 (left-hand portion in FIG. 2) is open, powder particles are retained in normal operation by the two parallel filter elements 26, 28 while clean gas is released to the surrounding area through the clean gas chamber 30 and line 24.

After a certain operating period, one of the two shut-off devices 64 is brought into the closed position (right-hand portion in FIG. 2), while gas continues to flow through the adjacent filter element 28 (left-hand portion). The second or clean gas supply system 92 is then activated such that pressure gas flows via the pressure gas distributor 96 from connections 100 through lines 103 to connections 102 and then via the flow channels 104 (FIG. 2) through the filter element (26) into the crude gas chamber 20. The vibration device 42 is switched on simultaneously by means of the control device 4 (FIG. 1), so that the frame 34 and the filter element 26 therein is knocked and/or vibrated, with the result that powder particles are detached from the filter element and conveyed into the crude gas chamber 20 by gravitation and by the flow generated by the second or clean gas supply system 92, until the filter element 26 is largely cleaned of powder particles. The shut-off device 64 is then returned to the open position, the vibration device 42 is switched off and the pressure gas supply to the second gas conveying means 92 is interrupted, so that a gas stream can again flow from the crude gas chamber 20 through the filter element 26 into the clean gas chamber 30.

If the left-hand filter element 28 in FIG. 2 needs to be cleaned, the procedure is the same as just described, while filter element 26 continues to be used for cleaning and for generating underpressure by gas being drawn from the side-channel compressor 22. While this is happening, filter element 28 is extensively cleaned of filter particles in the same manner as described in the foregoing. In this way, both of the parallel filter elements can be operated simultaneously and alternately cleaned in the manner described whenever this is necessary after a certain operating time. In this way, the filter system 16 and the coating apparatus 1 are able to operate continuously.

While the present invention has been illustrated by a description of various preferred embodiments and while these embodiments has been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein I claim:

1. A powder coating apparatus, comprising:
a crude gas chamber,
a clean gas chamber,
an air flow path between said clean gas chamber and said crude gas chamber,
a first filter element positioned in said air flow path,
a first gas discharge device configured to direct a first gas stream with powder particles therein in said air flow path from said crude gas chamber through said first filter element into said clean gas chamber,
a first shut-off device configured to interrupt the first gas stream through said first filter element,
a second gas discharge device configured to direct a second gas stream through said first filter element into said crude gas chamber, and
a first filter element moving device coupled to said first filter element and configured to move said first filter element in a manner which dislodges the powder particles therefrom.

2. The powder coating apparatus of claim 1, wherein said second gas discharge device further comprises:
a movable nozzle element mounted for movement relative to said first filter element, and
a drive mechanism coupled with said movable nozzle element and configured to move said nozzle element as the second gas stream is directed at said first filter element.

3. The powder coating apparatus of claim 1, further comprising:
a second filter element arranged in parallel with said first filter element,
a second shut-off device configured to interrupt the first gas stream through said second filter element, and
a second filter element moving device coupled to said second filter element and configured to move said second filter element in a manner which dislodges the powder particles therefrom.

4. The powder coating apparatus of claim 1, wherein said first filter element moving device further comprises a pneumatic cylinder capable of being intermittently charged with pressurized gas, and including a piston rod capable of reciprocating movement within said cylinder as a result of said cylinder being intermittently charged with the pressurized gas, and said reciprocating movement causing movement of said first filter element.

5. The powder coating apparatus of claim 1, wherein said second gas discharge device further comprises:
a rotatable nozzle element mounted for rotation relative to said first filter element, and
a drive mechanism coupled with said rotatable nozzle element and configured to rotate said nozzle element as the second gas stream is directed at said first filter element.

6. The powder coating apparatus of claim 5, wherein said rotatable nozzle element further comprises:
an elongated arm with a gas channel therein and a plurality of gas outlet channels directed at said first filter element.

7. The powder coating apparatus of claim 6, wherein said gas outlet channels are arranged such that said movable arm can be rotated by the gas flowing out of said gas outlet channels.

8. The powder coating apparatus of claim 7, wherein said gas outlet channels have respective spaced apart longitudinal axes and said movable arm rotates about a rotational axis, said longitudinal axes positioned on said arm and slanted with respect to said rotational axis at angles of 15°-30°.

9. The powder coating apparatus of claim 8, wherein said angles are each about 22°.

10. A method for cleaning a first filter element of powder particles filtered from a gas within a powder coating apparatus having a crude gas chamber and a clean gas chamber and the first filter element having first and second surface area portions positioned in an air flow path between the crude gas chamber and the clean gas chamber, the method comprising:
directing the gas mixed with the powder from the crude gas chamber through the first filter element into the clean gas chamber,
directing a cleaning gas stream through the first filter element in the direction of the clean gas chamber, and
moving the cleaning gas stream between the first and second surface area portions to dislodge the powder from the first filter element.

11. The method of claim 10, wherein moving the cleaning gas stream further comprises:
moving the cleaning gas stream in a rotational manner.

12. A method for cleaning a filter element of powder filtered from a gas within a powder coating apparatus having a crude gas chamber and a clean gas chamber and the first filter element positioned in an air flow path between the crude gas chamber and the clean gas chamber, comprising:
directing the gas mixed with the powder from the crude gas chamber through the first filter element into the clean gas chamber,
directing a cleaning gas stream through the first filter element in the direction of the clean gas chamber, and
moving the first filter element to dislodge the powder from the first filter element.

13. The method of claim 12, wherein moving the first filter element further comprises:
vibrating the first filter element.

14. A method for cleaning a filter element of powder filtered from a gas within a powder coating apparatus having a crude gas chamber and a clean gas chamber and first and second filter elements positioned in parallel in an air flow path between the crude gas chamber and the clean gas chamber, comprising:
directing the gas mixed with the powder from the crude gas chamber through the first and second filter elements into the clean gas chamber,
interrupting the flow of the gas mixed with the powder through the first filter element while maintaining the flow of the gas mixed with the powder through the second filter element,
directing a cleaning gas stream through the first filter element in the direction of the clean gas chamber, and
moving the first filter element to dislodge the powder from the first filter element.
